(19) United States
(12) Patent Application Publication
(10) Pub. No.: US 2020/0398453 A1
(43) Pub. Date: Dec. 24, 2020

(54) DIE CUTTING INSERT AND METHOD FOR CUTTING SHEET METALS

(71) Applicant: MAGNA INTERNATIONAL INC., Aurora (CA)

(72) Inventor: Stephen John PAUL, Telford, Shropshire (GB)

(21) Appl. No.: 16/979,105

(22) PCT Filed: Mar. 11, 2019
(86) PCT No.: PCT/CA2019/050295

§ 371 Date: Sep. 8, 2020

(30) Foreign Application Priority Data
Mar. 9, 2018 (GB) 1803816.6

(51) Int. Cl. B26F 1/40; B21D 28/02; B26F 1/44; B26D 7/26

(52) U.S. Cl. CPC B26F 1/405; B21D 28/02; B26D 2007/2607; B26D 7/26; B26F 1/44

(57) ABSTRACT

The present invention relates to a die cutting insert comprising a punch shoe having an angled guide surface. The die cutting assembly further comprises a trim punch arranged at least partly along the angled guide surface, such that the trim punch is movable along the angled guide surface between a first, extended position and a second, retracted position. In further aspects, the invention relates to a die cutting assembly and a method of cutting sheet metals.

This PCT International Patent Application claims the benefit of GB Patent Application Serial No. 1803816.6 filed on Mar. 9, 2018 and titled “Die Cutting Insert And Method For Cutting Sheet Metals”, the entire disclosure of which is hereby incorporated by reference.

### TECHNICAL FIELD

The present invention relates to a die cutting insert, particularly but not exclusively, to a die cutting insert for cutting sheet metals, such as steel or aluminium sheets. In another aspect the invention relates to a die cutting assembly and a method of cutting sheet metals.

### BACKGROUND

In die cutting, a die or die block is used as a specialised tool to cut or shape material, mostly sheet metals, using a press. Like moulds, die blocks are generally customised to the item that they are used to create. Die blocks are usually metal blocks, which are created by a tool manufacturer and subsequently mounted into a press. Die cutting machines further comprise a trim punch, which has a corresponding shape to the die block. The die block and trim punch can be thought of as female or male parts respectively, which are designed to move past each other's corresponding cutting edges to create a shearing force on the sheet metal arranged between them.

When die cutting metal sheets in a press, commonly known problem include the creation of slivers, galling and pluck back, particularly when cutting aluminium. Slivers are the result of aluminium interfacing with the cutting edge of the punches. While aluminium is a great material in that it only weighs a third of steel and exhibits an outstanding strength to weight ratio, in die cutting aluminium is particularly prone to the creation of slivers.

It is an aim of the present invention to address these disadvantages associated with the prior art. In particular, it is an object of the present invention to provide a die cutting insert, which reduces the formation of slivers during die cutting and, at the same time, does not require any more space and so can be retro-fitted to existing presses.

### SUMMARY OF THE INVENTION

Aspects and embodiments of the invention provide a die cutting insert, a die cutting assembly and a method of cutting sheet metals as claimed in the appended claims.

According to an aspect of the present invention, there is provided a die cutting insert comprising a punch shoe having an angled guide surface and a trim punch arranged at least partly along the angled guide surface such that the trim punch is moveable along the angled guide surface between a first, extended position and a second, retracted position.

With reference to the angled guide surface, it should be noted that traditional trim punches are arranged to move in one direction only, specifically up and down during the cutting process. They do not, however, move along two translatory axes. By contrast, the trim punch of the present die cutting insert may move up and down together with the press, when in use. At the same time, the punch can be moved independently of the press movement along the angled guide surface, that is, at an angle to the normally vertical movement of the press. That is, if the punch shoe of the present invention is aligned with the vertical direction of a press, the trim punch may be moved with respect to the punch shoe between its first and second position at an angle, that is partly in the vertical direction and partly in a horizontal direction with respect to the punch shoe and the material being cut.

As will be described in more detail below, the arrangement of the present invention has the advantage that, when in use, the trim punch not only moves in the vertical direction together with the press but can also increase the clearance between the punch and the die block and part being cut during the cutting/shearing process. It was found that increasing the clearance between the cutting edges of the punch and the component reduces friction and thereby significantly reduces the formation of slivers and the galling effect at the cutting edges. In particular, allowing the punch to move away from the cutting edge reduces punch/material contact in excess of 80% resulting in the aforementioned reduction in slivers/galling.

The new arrangement also enables cutting of the workpiece, without entering the die block. By contrast, in traditional die cutting arrangements, the punch has to “enter the die” on average by up to 5 mm. Combined with the thickness of a common workpiece (e.g. sheet metal) of about 3 mm, the punch has to be moved a total of 8 mm. This distance is the distance the punch descends to reach the “bottom dead centre”. After the cutting process, the punch returns to the “top dead centre” which will double the distance, resulting in a total punch movement of 16 mm in this case. A lot of heat/galling/slivers etc. is generated over this length, especially on aluminium. Another advantage of the present invention is, therefore, that the distance travelled by the punch per cutting operation is significantly reduced, as the punch does not have to enter the die block. In particular the workpiece may be cut at a distance of 50% or greater of the material thickness, i.e. after a vertical movement of about 1.5 mm in the above example (workpiece thickness of 3 mm). Having cut at 50% material thickness, the bottom edge of the punch would still be off the die face/cutting edge by about 1.5 mm, when the workpiece is cut and the punch reaches its “bottom dead centre”.

In another embodiment of the present invention, the trim punch comprises a flat bottom surface for engaging a workpiece, in use, wherein the angled guide surface extends at an oblique angle with respect to the bottom surface. The flat bottomed surface of the trim punch typically extends in a horizontal direction, when used in a die cutting press. Arranging the angled guide surface at an oblique angle with respect to the flat bottomed surface will ensure that the trim punch is moveable in two translatory directions with respect to the workpiece.

The trim punch may comprise an angled side surface, wherein the angled side surface extends at the same angle as the angled guide surface with respect to the bottom surface. Accordingly, if the trim punch is moved along the angled guide surface of the punch shoe between its first and second position, the flat bottomed surface remains in a predetermined orientation with respect to the workpiece, usually a horizontal orientation.

According to yet another embodiment, the trim punch comprises a protrusion extending below the flat bottom surface of the trim punch. The protrusion may be arranged to engage the workpiece before the bottom surface. More particularly, the protrusion may be configured to engage the workpiece before the cutting edge of the trim punch. The protrusion is, thus, adapted to apply a pre-tension to the workpiece, before the bottom surface and/or the cutting edge comes into contact with the material of the workpiece. The protrusion also ensures that the trim punch is seated correctly and firmly with respect to the punch shoe and a correct clearance between the trim punch and the die block is set, before a cutting operation is performed.

According to another embodiment, the trim punch is connected to the punch shoe by means of a resilient member. The resilient member may facilitate movement of the trim punch with respect to the punch shoe between its first and second position. Particularly, the resilient member may be arranged to bias the trim punch towards its first, extended position. As such, the first position is also the resting (or non-cutting) position of the trim punch. If the punch shoe and the trim punch are lowered towards a workpiece by the press, the aforementioned bottom surface of the trim punch will engage the workpiece. Once the workpiece is engaged by the trim punch, a reaction force will act to move the trim punch with respect to the punch shoe from its first, extended position into its second, retracted (or cutting) position thereby gradually increasing the restoring force of the resilient member arranged between the trim punch and the punch shoe. In this embodiment, the force applied on the workpiece is, therefore, gradually increased by means of the restoring force of the resilient member, until the trim punch has reached its second, retracted position. In its second, retracted position, the trim punch preferably abuts against the punch shoe and is moved together with the latter along the vertical direction by the press, until the workpiece has been cut.

In another embodiment, the punch shoe comprises a recess defining the angled guide surface and a shoulder portion, the shoulder portion extending substantially perpendicular to the angled guide surface. The trim punch may comprise a top surface opposite the flat bottomed surface, the top surface extending in substantially the same direction as the shoulder portion of the punch shoe. In other words, the shoulder portion of the punch shoe and the top surface of the trim punch are corresponding faces and are configured to rest against each other when the trim punch is in its second, retracted position.

The resilient member may have a first end connected to the shoulder portion and a second end connected to the top surface of the trim punch. The resilient member will then be oriented substantially identical to the angled guide surface, thus most efficiently biasing the trim punch towards its first position with respect to the punch shoe.

In yet another embodiment, the trim punch comprises a tongue protruding from the top surface in the same direction as the angled side surface, wherein the punch shoe comprises a groove for receiving a tongue of the trim punch. The tongue and groove arrangement of the present die cutting insert will ensure alignment of the trim punch along the angled guide surface of the punch shoe at all times. In particular, the tongue and groove may be arranged such that the tongue is fully received within the groove when the trim punch is in its second, retracted position. When the trim punch is moved into its first, extended position, the tongue is gradually pulled out of the groove. However, the tongue and groove may be sized that even in the first, extended position at least a part of the tongue is still received within the groove.

In another aspect of the present invention, there is provided a die cutting assembly comprising the above die cutting insert and a die block having a die block cutting edge. The trim punch and punch shoe may be arranged in such a way that the cutting edge of the die block is aligned with a cutting edge of the trim punch. The die cutting assembly may comprise a lower shoe arranged to support the die block. The die cutting assembly may further comprise a punch holder arranged to support the punch shoe, wherein at least one guide post is arranged between the punch holder and the lower shoe. The at least one guide post is arranged to facilitate vertical movement of the punch shoe and trim punch with respect to the die block as the press opens and closes. Of course, the guide posts may also be arranged as actuators for vertically moving the press.

In another aspect of the present invention, there is provided a method of cutting sheet metals comprising:

providing a die block having a die block cutting edge;

providing a trim punch with a punch edge movable with respect to the die block;

arranging a sheet metal on the die block, such that a part of the sheet metal protrudes over the die cutting edge;

moving the trim punch into contact with the protruding part of the sheet metal and past the die block cutting edge so as to create a shearing force on the sheet metal and, at the same time, moving the trim punch such that a clearance between the punch edge and the die block cutting edge increases as the trim punch moves past the block cutting edge.

The method may comprise moving the trim punch along an angled guide surface of a corresponding punch shoe as the trim punch contacts the sheet metal. This embodiment resembles a particularly simple way of moving the trim punch past the die block cutting edge and at the same time increasing the clearance between the trim punch and the die block.

In another embodiment, the trim punch is moved with respect to the punch shoe between a first, extended position and a second, retracted position, as the trim punch engages the protruding part of the sheet metal, such that a shearing force applied by the trim punch on the sheet metal increases gradually as the trim punch is moved between its first and second positions. In one embodiment, the trim punch may be biased towards its first position by means of a resilient member, wherein moving the trim punch from its first and second position acts against a bias of the resilient member.

In yet a further embodiment, the resilient member moves the trim punch towards its first, extended position as the sheet metal is cut so as to accelerate the cut (scrap) part of the sheet metal in the direction of the angled guide surface of the punch shoe. In other words, the trim punch will accelerate the scrap part of the sheet metal not only in a vertical but also in a horizontal direction, away from the remaining workpiece.

Within the scope of this application it is expressly intended that the various aspects, embodiments, examples and alternatives set out in the preceding paragraphs, in the claims and/or following description and the drawings, and in particular in the individual features thereof, may be taken independently or in any combination. That is, all embodiments and/or features of any embodiment can be combined in any way and/or a combination, and as such those features are compatible.

The applicant reserves the right to change any originally filed claim or to file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a die cutting press in a trimming application according to the state of the art;

FIG. 2 shows a perspective side view of the die cutting insert according to the present invention;

FIGS. 3a to 3c show a method of cutting sheet metals using the die cutting insert shown in FIG. 2.

### DETAILED DESCRIPTION

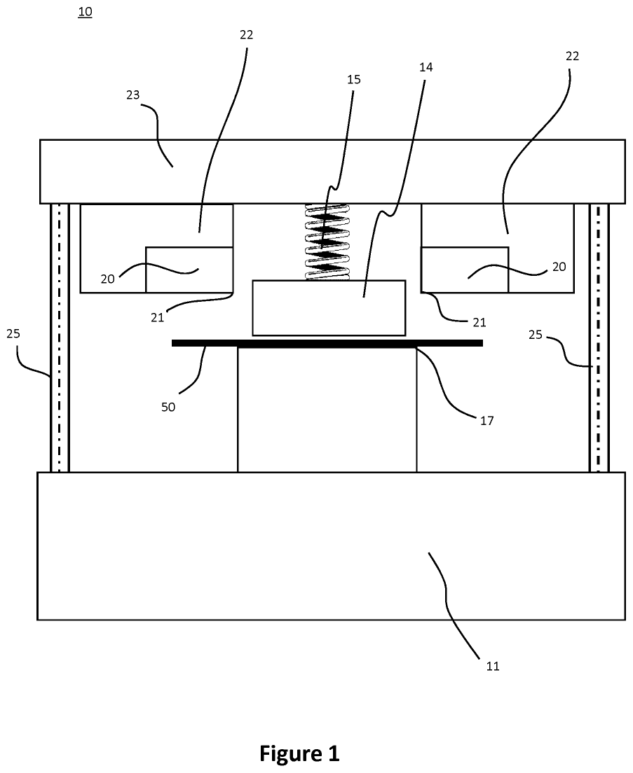

Turning to FIG. 1, there is shown a prior art die cutting assembly 10, particularly a trimming device. The die cutting assembly 10 comprises a die block 11 arranged at a lower end of the assembly. The die block 11 may be supported by a lower shoe 12 of a press. The die block 11 defines a support surface, which is configured to support a workpiece 50, for example a metal sheet, during operation. A stripper 14 is arranged above the die block 11 in FIG. 1. The workpiece 50 is arranged between the die block and the stripper 14 and extends sideways over a cutting edge 17 of the die block.

At the top end of FIG. 1, there is shown a schematic punch holder 23 arranged to support a die cutting insert comprising one or more punch shoes 22 and corresponding trim punches. The punch shoes 22 each support a corresponding trim punch 20 in alignment with the cutting edge 17 of the die block 11. The trim punches 20 are arranged with respect to the cutting edge 17 of the die block 11 such that a sufficient horizontal clearance exists between a punch edge 21 of the trim punch and the cutting edge 17.

One or more guide posts 25 facilitate vertical movement of the punch holder 23, together with the punch shoes 22 and trim punch 20 with respect to the lower shoe 12 and/or die block 11. As the trim punches 20 are moved downwards together with the punch holder 23 in FIG. 1, the stripper 14 engages a top surface of workpiece 50 and clamps the latter between itself and the support surface of the die block 11. Further downwards movement of the punch holder 23 with respect to the die block 11 will cause the spring 15 of the stripper 14 to compress, thereby increasing the force applied by the striper onto the top surface of the workpiece 50.

The punch holder 23, and thus the punch shoes 22 and trim punches 20, are moved downwards until respective punch edges 21 of the trim punches 20 are moved past the cutting edge 17 of the die block 11. As is well known in the art, a certain clearance between the cutting edge 17 and the punch edge 21 needs to be maintained in order to achieve an optimal cut. As the punch edges 21 move past the cutting edges 17, deformation occurs in the workpiece 50 leading to shearing forces along the cutting edge 17 until parts of the workpiece 50 that are contacted by the trim punch 20 are removed from the workpiece 50 and ejected as scrap.

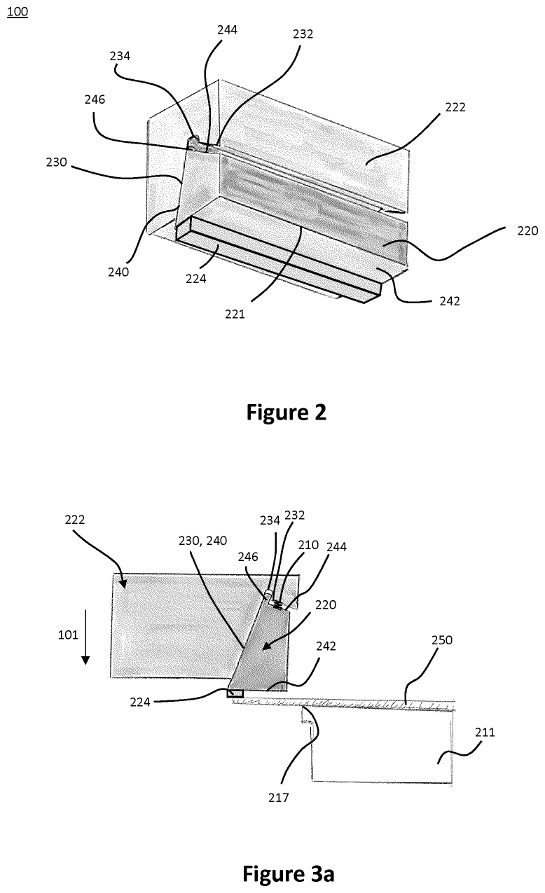

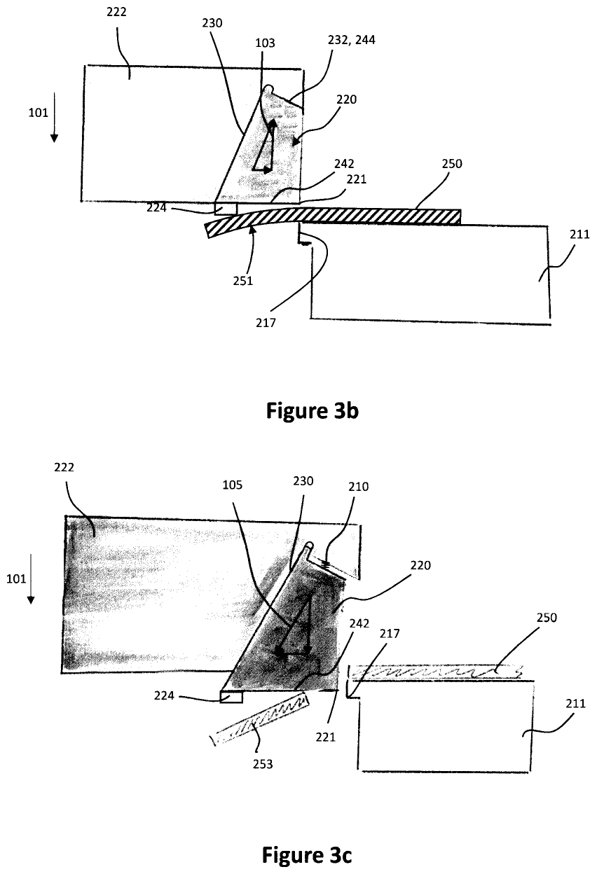

As mentioned hereinbefore, the die cutting assembly of FIG. 1 has the disadvantage that large amounts of slivers may form at the interface between punch edge 21 and the cutting edge 17 as the workpiece 50 is cut. The present invention tries to overcome this issue by suggesting a new die cutting insert shown in FIGS. 2 to 3c. FIG. 2 is a perspective side view of an embodiment of the die cutting insert 100 according to the present invention. The new die cutting insert is arranged to be inserted into a conventional punch holder, such as punch holder 23 described hereinbefore with reference to FIG. 1. The die cutting insert comprises a punch shoe 222 and a trim punch 220, defining a punch edge 221. The trim punch 220 is arranged at least partly along an angled guide surface 230 of the punch shoe 222. The trim punch 220 comprises an angled side surface 240 that engages the angled guide surface 230 of the punch shoe 222.

The punch shoe 220 comprises a recess defining the angled guide surface 230 and a shoulder portion 232. As will be appreciated from FIG. 3a, the angled guide surface 230 and the angled side surface 240 both extend at an oblique angle with respect to the horizontal direction. In other words, the angled guide surface 230 and the angled side surface 240 extend at an oblique angle to a bottom surface 242 of the trim punch 220. The shoulder portion 232 of the punch shoe 222 extends at about 90 degrees with respect to the angled guide surface 230. A groove 234 is provided in the shoulder portion 232 of the punch shoe 222. The groove 234 is generally an extension of the angled guide surface 230 and therefore extends in the same direction as the latter.

The trim punch 220 comprises a top surface 244 opposite the flat bottomed surface 242. The top surface 244 extends at a substantially right angle with respect to the angled side surface 240. As such, the top surface 244 extends in essentially the same direction as the shoulder portion 232 of the punch shoe 222. As will be described in more detail below, in its second, retracted position, the top surface 244 abuts against the shoulder portion 232. A tongue 246 protrudes from the top surface 244 of the trim punch 220. The tongue 246 is configured to be fully received within groove 234 of the punch 222 when the trim punch 220 is in its second, retracted position.

A protrusion 224 extends from the flat bottom surface 242 of the trim punch 220. As will be described in more detail below, the protrusion may be shaped and sized so as to engage the workpiece before the punch edge 221.

Referring to the side view of FIG. 3a, for example, a resilient member, particularly a spring 210 is arranged between the punch shoe 222 and the trim punch 220. The spring has a first end connected to the shoulder portion 232 and a second end connected to the upper surface 244 of the trim punch 220. The spring 210 is orientated in the same direction as the angled guide surface 230 and therefore acts to move the trim punch 220 along said guide surface 230. The spring 210 biases the trim punch 220 towards its first, extended position, as can be derived from FIG. 3a.

### Operation

The functionality of the new cutting assembly can be derived from FIGS. 3a to 3c. Turning to FIG. 3a, there is shown a first state in which the die cutting insert, including the punch shoe 222 and the trim punch 220, approaches a workpiece 250, which is supported by a die block 211. The punch shoe 222 and trim punch 220 are moved together in the direction of arrow 101, towards the workpiece 250. In a typical cutting press, the direction of arrow 101 corresponds to the vertical direction.

While the punch shoe 222 and the trim punch 220 are approaching the workpiece 250, the trim punch 220 is in its first, extended position with respect to the punch shoe 222. In other words, the top surface 244 of the trim punch 220 is distanced from the shoulder portion 232 of the punch shoe 222 by means of spring 210 that biases the trim punch 220 towards its first position. That is, if no force is applied to the bottom surface 242 or the protrusion 224 of the trim punch 220, the latter remains in its first, extended/non-cutting position.

As can further be derived from FIG. 3a, there is a larger than normal clearance between the trim punch edge 221 and the cutting edge 217 of the die block 211. This larger than normal clearance between the two cutting edges will be compensated by movement of the trim punch 220 with respect to the punch shoe 222 along the angled guide surface 230, as will be described in more detail below.

FIG. 3b depicts a situation in which the protrusion 224 of the punch shoe 220 has been brought into contact with the workpiece 250. In particular, the protrusion is brought into contact with a protruding part 251 of workpiece 250, which extends over the cutting edge 217 of the die block 211. Preferably, the bottom surface 242 and the punch edge 221 will not yet have contacted the workpiece 250.

As described hereinbefore with reference to FIG. 3a, the trim punch 220 initially moves together with the punch shoe 222 towards the workpiece 250, in the direction of arrow 101. This is the case until the protrusion 224 of the trim punch first contacts the protruding part 251 of the workpiece 250. As the punch shoe 222 is further advanced in the direction of arrow 101, i.e. towards the workpiece 250, the trim punch 220 is forced towards shoulder portion 232 of the punch shoe 222 against the resilient force of the spring 210. As the trim punch 220 is forced towards the shoulder portion 232, it moves along the angled guide surface 230 of the punch shoe 222, that is, in the direction of arrow 103, i.e. parallel to the angled guide surface 230. As indicated by arrow 103, this movement of the trim punch 220 includes a first component (vertical) which is aligned with direction 101 and a second component (horizontal), which will act to reduce the horizontal clearance between the punch edge 221 and the cutting edge 217 of the die block 211.

It will be understood that the resilient force of the spring 210 is configured to be below a force at which the protruding part 251 of workpiece 250 will start breaking. Accordingly, the protruding part 251 of the workpiece 250 will remain attached to the workpiece 250 at least for as long as the trim punch 220 is moved from its first, extended position (FIG. 3a) into its second, retracted position shown in FIG. 3b. Instead, the protrusion 224 will apply a pre-tension to the protruding part 251 of the workpiece that will result in a deformation of the workpiece 250 as depicted in FIG. 3b. As the trim punch 220 is moved towards its second, retracted position, the force applied to the protruding part 251 of the workpiece 250 gradually increases depending on the characteristics of the spring 210, namely the spring factor.

Once the trim punch 220 has reached its second, retracted position shown in FIG. 3b, the force applied to the workpiece 250 will now further increase, determined by the pressure exerted by the press moving the punch shoe 222. This increased force will eventually close the gap between the bottom surface 242/punch edge 221 of the trim punch 220 and the workpiece 250. As a consequence, the punch edge 221 moves past a cutting edge 217 of the die block 211 and introduces shearing forces that cause the protruding part 251 of the workpiece 250 to break off and be ejected as scrap part 253. However, as the scrap parts 253 start breaking off, the reactive force of the workpiece, which holds the trim punch 220 in its second, retracted position, quickly disappears, causing the spring 210 to extend again and move the trim punch 220 into its first, extended position.

As a result of the movement of the trim punch 220 from its second, retracted position to its first, extended position, the trim punch 220 is accelerated in the direction of arrow 105, which is opposite to direction 103 described hereinbefore with reference to FIG. 3b. Direction 105 is, of course, aligned with the angled guide surface 230 and therefore includes two force components, one of which extends along direction 101 (vertical direction), while the other extends perpendicular thereto (in a horizontal direction) thereby increasing the clearance between the trim punch edge 221 and the cutting edge 217 of the die block 211. Particularly the force component in the horizontal direction, that is, the force component moving the trim punch 220 away from the cutting edge 217, will act on the scrap part 253 and thus accelerate the latter away from cutting edge 217 just before breaking occurs. It is this particular increase in the clearance gap and the acceleration of the scrap part 253 away from the cutting edge 217 that will significantly reduce the amount of slivers formed at the cutting face.

1. A die cutting insert comprising:
a punch shoe having an angled guide surface;
a trim punch arranged at least partly along the angled guide surface, such that the trim punch is movable along the angled guide surface between a first, extended position and a second, retracted position.

2. The die cutting insert of claim 1, wherein the trim punch comprises a flat bottom surface for engaging a workpiece, in use, wherein the angled guide surface of the punch shoe extends at an oblique angle with respect to the bottom surface.

3. The die cutting insert of claim 2, wherein the trim punch comprises an angled side surface, wherein the angled side surface extends at the same angle as the angled guide surface with respect to the bottom surface.

4. The die cutting insert of claim 2, wherein the trim punch comprises a protrusion extending below the flat bottom surface of the trim punch.

5. The die cutting insert of claim 1, wherein the trim punch is connected to the punch shoe by a resilient member.

6. The die cutting insert of claim 5, wherein the resilient member is arranged to bias the trim punch towards its first position.

7. The die cutting insert of claim 1, wherein the punch shoe comprises a recess defining the angled guide surface and a shoulder portion, the shoulder portion extending substantially perpendicular to the angled guide surface.

8. The die cutting insert of claim 7, wherein the trim punch comprises a top surface opposite the flat bottom surface, the top surface extends in substantially the same direction as the shoulder portion of the punch shoe.

9. The die cutting insert of claim 8, wherein the resilient member has a first end connected to the shoulder portion of the punch shoe and a second end connected to top surface of the trim punch.

10. The die cutting insert of claim 8, wherein the trim punch comprises a tongue protruding from the top surface in the same direction as the angled side surface, and
wherein the punch shoe comprises a groove for receiving the tongue of the trim punch.

11. A die cutting assembly comprising a die cutting insert of claim 1, wherein the assembly further comprises a die block having a die block cutting edge.

12. The die cutting assembly of claim 11 comprising a lower shoe arranged to support the die block.

13. The die cutting assembly of claim 12 comprising a punch holder arranged to support the punch shoe, and wherein at least one guide post is arranged between the punch holder and the lower shoe.

14. A method of cutting sheet metals comprising:
providing a die block having a die block cutting edge;
providing a trim punch with a punch edge movable with respect to the die block;
arranging a sheet metal on the die block, such that a part of the sheet metal protrudes over the die cutting edge;
moving the trim punch into contact with the protruding part of the sheet metal and past the die block cutting edge so as to create a shearing force on the sheet metal and, at the same time, moving the trim punch such that a clearance between the punch edge, the die block cutting edge and the workpiece increases as the trim punch moves past the block cutting edge.

15. The method of claim 14, wherein the trim punch is moved along an angled guide surface as the trim punch contacts the sheet metal.

16. The method of claim 15, including moving the trim punch with respect to the punch shoe between a first, extended position, and a second retracted, position, as the trim punch engages the protruding part of the sheet metal, such that a shearing force applied by the trim punch on the sheet metal increases gradually as the trim punch is moved between its first and second position.

17. The method of claim 16, wherein the trim punch is biased towards its first position by means of a resilient member and wherein moving the trim punch from its first to its second position acts against the bias of the resilient member.

18. The method of claim 17, wherein the resilient member moves the trim punch towards its first, expanded position as the sheet metal is cut so as to accelerate the cut part of the sheet metal in the direction of the angled guide surface of the punch shoe.

19. The die cutting insert of claim 3, wherein the trim punch comprises a protrusion extending below the flat bottom surface of the trim punch.

20. The die cutting insert of claim 9, wherein the trim punch comprises a tongue protruding from the top surface in the same direction as the angled side surface, and
wherein the punch shoe comprises a groove for receiving the tongue of the trim punch.
